(19) United States
(12) Patent Application Publication
(10) Pub. No.: US 2026/0219082 A1
(43) Pub. Date: Jul. 30, 2026

(54) MAGNETIC-INDUCTIVE FLOW METER

(71) Applicant: Endress+Hauser Flowtec AG, Reinach (CH)

(72) Inventors: Oliver Graf, Känerkinden (CH); Raphael Hess, Duggingen (CH); Thomas Küng, Münchenstein (CH); Simon Mariager, Basel (CH)

(21) Appl. No.: 19/141,737

(22) PCT Filed: Dec. 13, 2023
(86) PCT No.: PCT/EP2023/085602

§ 371 Date: Jun. 20, 2025

(30) Foreign Application Priority Data
Dec. 20, 2022 (DE) 10 2022 134 109.7

(51) Int. Cl. G01F 1/58

(52) U.S. Cl. CPC G01F 1/584; G01F 1/588

(57) ABSTRACT

A magnetic-inductive flow meter for determining a flow-velocity-dependent measurement variable of a flowable medium includes a measuring tube for guiding the medium, a magnetic-field-generating device, and at least one measuring electrode. The measuring electrode is arranged in a measuring electrode opening and has a measuring electrode head configured to come into contact with the medium. A reference electrode connects the medium to a reference potential, and is arranged in a reference electrode opening where the reference electrode has a reference electrode head configured to come into contact with the medium. The reference electrode head has, in a cross-sectional plane of the measuring tube intersecting the reference electrode and the at least one measuring electrode, a reference electrode diameter, where the measuring electrode head has, in the cross-sectional plane, a measuring electrode diameter such that the reference electrode diameter is at least 10% smaller than the measuring electrode diameter.

The invention relates to a magnetic-inductive flow meter.

Magnetic-inductive flow meters are used for determining the flow rate and the volumetric flow of a flowing medium in a pipe. A distinction is made here between in-line magnetic-inductive flow meters and magnetic-inductive flow measurement probes, which are inserted into a lateral opening of a pipe. A magnetic-inductive flow meter has a magnetic-field-generating device for generating a magnetic field. A main axis of the magnetic field runs essentially perpendicular to the flow direction of the flowing medium. Saddle coils or solenoids are usually used for this purpose. In order to realize a predominantly homogeneous magnetic field, pole shoes are additionally formed and attached relative to the flow direction such that the magnetic field lines run over the entire tube cross-section essentially perpendicular to the transverse axis or in parallel with the vertical axis of the measuring tube. In addition, a magnetic-inductive flow meter has a measuring tube for guiding the medium on the outer lateral face of which the magnetic-field-generating device is arranged. A pair of measuring electrodes attached to the lateral surface of the measuring tube taps a measurement voltage or potential difference which is perpendicular to the direction of flow and to the magnetic field and arises when a conductive medium flows in the direction of flow when the magnetic field is applied. Since, according to Faraday's law of induction, the tapped measurement voltage depends upon the velocity of the flowing medium, the flow rate and/or, with the inclusion of a known tube cross-section, the volumetric flow can be determined from the measured induced measurement voltage.

In contrast to a magnetic-inductive flow meter, which comprises a measuring tube for guiding the medium with an attached device for generating a magnetic field penetrating the measuring tube and which also comprises measuring electrodes, magnetic-inductive flow measurement probes are inserted with their usually circular-cylindrical housings into a lateral opening of a pipe and fastened in a fluid-tight manner. A special measuring tube is no longer necessary. The measuring electrode arrangement and coil arrangement, mentioned at the outset, on the lateral surface of the measuring tube are omitted and are replaced by a device for producing a magnetic field, which device is arranged in the interior of the housing and in direct proximity to the measuring electrodes and is designed such that an axis of symmetry of the magnetic field lines of the produced magnetic field perpendicularly intersects the front face or the face between the measuring electrodes. In the prior art, there are already a plurality of different magnetic-inductive flow measurement probes.

Magnetic-inductive flow meters are often used in process and automation engineering for fluids, starting from an electrical conductivity of approximately 5 μS/cm. Corresponding flow measurement devices are sold by the applicant in a wide variety of embodiments for various fields of application—for example, under the names PROMAG or MAGPHANT.

Magnetic-inductive flow meters with small nominal diameters (less than 80 millimeters) suffer from the fact that the measurement inaccuracy increases as the conductivity of the medium decreases (less than 10³ μS/cm).

The object of the invention is to remedy this problem.

The object is achieved by the magnetic-inductive flow meter according to claims 1 and 5.

The magnetic-inductive flow meter according to the invention for determining a flow-rate-dependent measurement variable of a flowable medium comprises:
a measuring tube for guiding the medium;
a magnetic-field-generating device for generating a magnetic field that penetrates the measuring tube;
at least one measuring electrode for tapping a measurement voltage induced in the medium,
   wherein the measuring electrode is arranged in a measuring electrode opening in the measuring tube,
   wherein the measuring electrode has a measuring electrode head which is configured to come into contact with the medium;
a reference electrode for connecting the medium to a reference potential,
   wherein the reference electrode is arranged in a reference electrode opening in the measuring tube,
   wherein the reference electrode has a reference electrode head which is configured to come into contact with the medium,
   wherein the reference electrode head has, in a cross-sectional plane A of the measuring tube intersecting the reference electrode and the at least one measuring electrode, a reference electrode diameter D_{RE},
   wherein the measuring electrode head has, in the cross-sectional plane A, a measuring electrode diameter D_{ME},
characterized in that
   the reference electrode diameter D_{RE} is in particular at least 10% and preferably at least 25% less than the measuring electrode diameter D_{ME}.

The advantage of this solution is that, by reducing the reference electrode diameter D_{RE}, a significant reduction in the measurement error for media with low conductivity (i.e., σ<10³ μS/cm) is achieved.

Advantageous embodiments of the invention are the subject matter of the dependent claims.

One embodiment provides that a ratio D_{ME}/D_{RE} be greater than 1.3, in particular greater than 1.6 and preferably greater than 2.

One embodiment provides that the measuring tube have a measuring tube diameter D_{MR},
wherein, for a ratio R=D_{RE}/D_{MR}, the following applies: 0.05≤R≤0.25, in particular 0.1≤R≤0.2 and preferably 0.13≤R≤0.17.

One embodiment provides that a minimum distance d₁ between the measuring electrode and the reference electrodes be greater than 5 millimeters, in particular greater than 7 millimeters and preferably greater than 10 millimeters.

The object is also achieved by the magnetic-inductive flow meter according to the invention for determining a flow-rate-dependent measurement variable of a flowable medium, comprising:
a measuring tube for guiding the medium;
a magnetic-field-generating device for generating a magnetic field that penetrates the measuring tube;
at least one measuring electrode for tapping a measurement voltage induced in the medium,
   wherein the measuring electrode is arranged in a measuring electrode opening in the measuring tube,
   wherein the measuring electrode has a measuring electrode head which is configured to come into contact with the medium;
a fill-level monitoring electrode is arranged in a fill-level monitoring electrode opening of the measuring tube,
   wherein the fill-level monitoring electrode has a fill-level monitoring electrode head,
   wherein the fill-level monitoring electrode head is configured to come into contact with the medium,
   wherein the fill-level monitoring electrode head has, in a cross-sectional plane A of the measuring tube intersecting the fill-level monitoring electrode and the at least one measuring electrode, a fill-level monitoring electrode diameter D_{FÜ},
   wherein the measuring electrode head has, in the cross-sectional plane A, a measuring electrode diameter D_{ME},
   characterized in that the fill-level monitoring electrode diameter D_{FÜ} is in particular at least 10% and preferably at least 25% less than the measuring electrode diameter D_{ME}.

One embodiment provides that a minimum distance d₂ between the measuring electrode and the reference electrodes be greater than 5 millimeters, in particular greater than 7 millimeters and preferably greater than 10 millimeters.

One embodiment provides that a ratio D_{ME}/D_{FÜ} be greater than 1.3, in particular greater than 1.6 and preferably greater than 2.

One embodiment provides that the measuring tube have a measuring tube diameter D_{MR},
wherein the measuring tube diameter D_{MR} is greater than the fill-level monitoring electrode diameter D_{FÜ},
wherein, for a ratio r=D_{FÜ}/D_{MR}, the following applies: 0.05≤R≤0.25, in particular 0.1≤R≤0.2 and preferably 0.13≤R≤0.17.

One embodiment provides that a longitudinal plane intersecting the reference electrode and/or the fill-level monitoring electrode divide the measuring tube into a first measuring tube section and a second measuring tube section,
wherein two measuring electrodes are arranged in the first measuring tube section,
wherein the two measuring electrodes span a midpoint angle α of 30≤α≤60°, in particular 40≤α≤50°.

One embodiment provides that the measuring tube diameter D_{MR} be less than 80 millimeters, in particular less than 50 millimeters.

One embodiment provides that the measuring electrode and the reference electrode and/or the fill-level monitoring electrode be arranged on the measuring tube in such a way that they are intersected by the common cross-sectional plane A of the measuring tube.

The invention is explained in greater detail with reference to the following figures, in which:

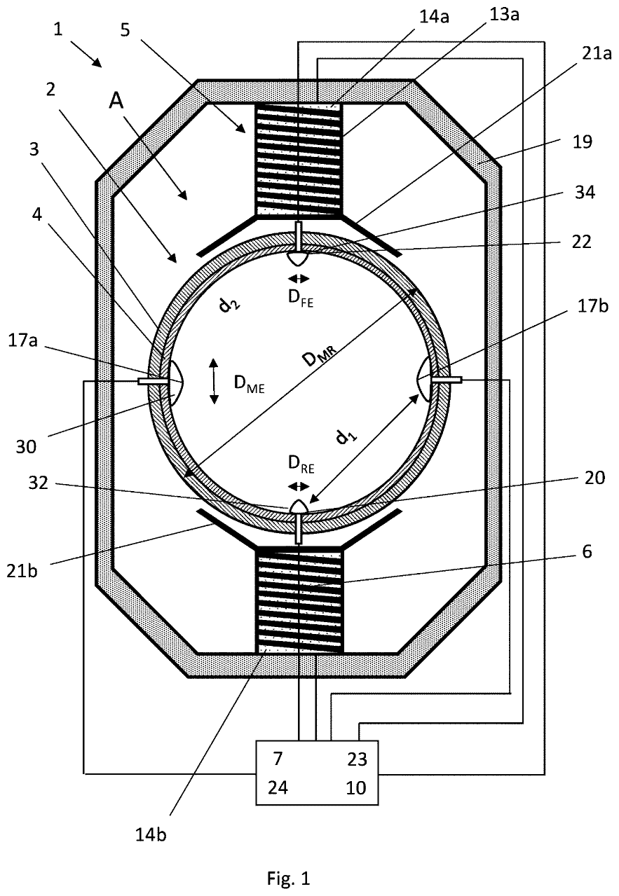

FIG. 1 shows a cross-section through a first embodiment of the magnetic-inductive flow meter according to the invention;

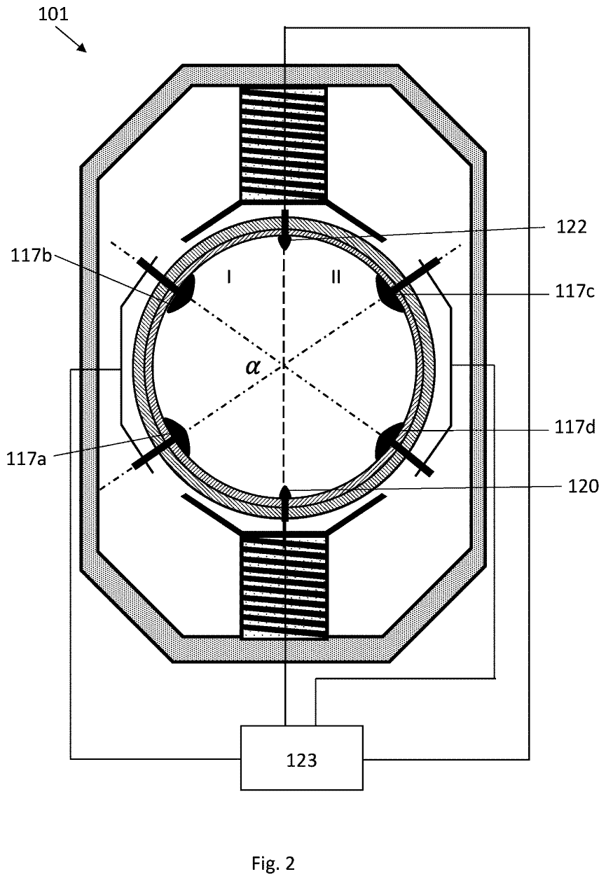

FIG. 2 shows a cross-section through a second embodiment of the magnetic-inductive flow meter according to the invention; and

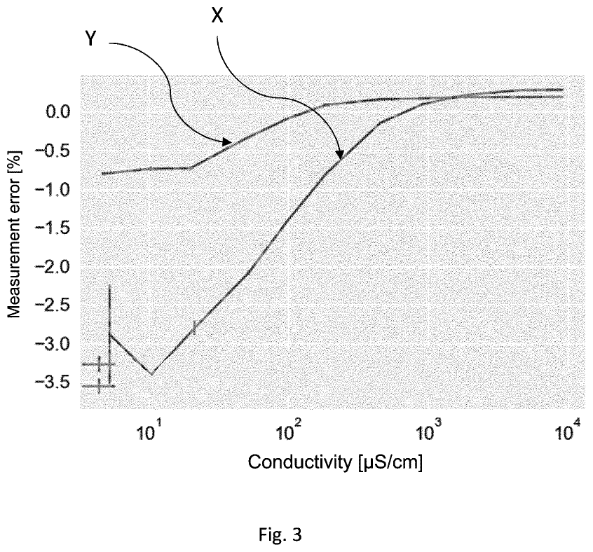

FIG. 3 shows measurement data for a conventional magnetic-inductive flow meter and a magnetic-inductive flow meter according to the invention.

FIG. 1 shows a cross-section through a first embodiment of the magnetic-inductive flow meter 1 according to the invention. The structure and measuring principle of a magnetic-inductive flow meter 1 are known in principle. A flowable medium having a (minimum) electrical conductivity is guided through a measuring tube 2. The measuring tube 2 comprises a carrier tube 3, which is usually made of, or at least comprises, steel, ceramic, plastic, or glass. An electrically insulating material is applied to the inner lateral surface of the carrier tube 3.

A magnetic-field-generating device 5 for generating a magnetic field is arranged on the carrier tube 3 such that the magnetic field lines are oriented substantially perpendicularly to a longitudinal direction defined by a measuring tube axis of the measuring tube. The magnetic-field-generating device 5 typically comprises a saddle coil or at least one solenoid 6i. A coil core 14i usually extends through a receptacle 15 of the coil 6i. The receptacle 15 is to be understood as the volume which is bounded by the coil wire that forms the coil 6i. The receptacle 15 of the coil 6i can thus be formed by a coil holder or by the imaginary enclosed volume. The latter occurs when the coil wire of the coil 6i is wound directly around the coil core 14i. The coil core 14i is formed from a magnetically conductive, in particular soft, magnetic material. The magnetic-field-generating device 5 for generating the magnetic field comprises a pole shoe 21i which is arranged at one end of the coil core 14i. The pole shoe 21i can be a separate component or can be monolithically connected to the coil core 14i. In the embodiment shown in FIG. 1, two diametrically arranged coils 6a, 6b each have a coil core 14a, 14b and a pole shoe 21a, 21b. The two coil cores 14a, 14b are connected to one another via a field return 22. The field return 22 connects each of the sides of the coil cores 14a, 14b that face away from one another. However, magnetic-inductive flow meters with exactly one coil 6 having exactly one coil core 14 and without a field return are also known.

The coil 6 is connected to an operating circuit 7 which operates the coil 6 by means of an operating signal. The operating signal can be a voltage with a time-variable curve and is characterized by operating signal parameters, wherein at least one of the operating signal parameters is controllable. The magnetic field generated by the device 5 for producing the magnetic field is produced by means of a pulsed direct current of alternating polarity provided by an operating circuit 7. This ensures a stable zero point and makes the measurement insensitive to influences due to electrochemical disturbances. The two coils 6a, 6b can be separately connected to the operating circuit 7 or connected in series or in parallel with one another.

When the magnetic field is applied, a flow-rate-dependent potential distribution results in the measuring tube 2, which can be detected, for example, in the form of an induced measurement voltage. A device 8 for tapping the induced measurement voltage is arranged on the measuring tube 2. In the embodiment shown, the device 8 for tapping the induced measurement voltage is formed by two, oppositely arranged measuring electrodes 17a and 18b in order to form a galvanic contact with the medium. However, magnetic-inductive flow meters are known which have measuring electrodes arranged on the outer wall of the carrier tube 3 that are not in contact with the medium. The measuring electrodes 17a, 18b are generally arranged diametrically and form an electrode axis, or are intersected by a transverse axis which runs perpendicular to the magnetic field lines and the longitudinal axis of the measuring tube 2. However, devices 8 intended for tapping the induced measurement voltage and having more than two measuring electrodes are also known. The flow-rate-dependent measurement variable can be determined on the basis of the measured measurement voltage. The flow-rate-dependent measurement variable comprises the flow rate, the volumetric flow, and/or the mass flow of the medium. A measuring circuit 23 is configured to detect the induced measurement voltage applied to the measuring electrodes 17a, 17b, the respective existing electrical potentials, or a difference between the existing electrical potentials, and an evaluation circuit 24 is configured to determine the flow-rate-dependent measured variable. The evaluation circuit 24 can be part of the transmitter or the transducer. The measuring electrodes 17a, 17b are usually made of metal.

The carrier tube 3 is often formed from an electrically conductive material such as steel. In order to prevent the measurement voltage applied to the measuring electrodes 17a, 17b from being conducted away via the carrier tube 3, the inner wall is lined with an insulating material—for example, a (plastic) liner 4.

Commercially available magnetic-inductive flow meters have two further electrodes 19, 20, which are usually also metallic, in addition to the measuring electrodes 17a, 17b. On the one hand, a fill-level monitoring electrode 19, optimally mounted at the highest point in the measuring tube 2, serves to detect partial filling of the measuring tube 1. Furthermore, it is configured to forward this information to the user and/or to take the fill level into account when determining the volume flow. In addition, a reference electrode 20, which is usually attached diametrically to the fill-level monitoring electrode 19 or at the lowest point of the measuring tube cross-section, serves to set a controlled electrical potential in the medium. As a rule, the reference electrode 20 is used to connect the flowing medium to an electrical ground potential.

The operating circuit 7, controller circuit 10, measuring circuit 23, and evaluation circuit 24 can be part of a single electronic circuit or can form individual circuits. The measuring, operating, and/or evaluation circuit 7, 23, 24 is designed to carry out the method according to the invention. For this purpose, the operating circuit is designed to generate the operating signal and provide it to the magnetic field-generating device. Furthermore, the measuring circuit is designed to determine the measurement voltage values and forward them to the evaluation circuit. The evaluation circuit is designed to determine the current zero point and to take it into account for the determination of the flow-rate-dependent measurement variable.

The magnetic-inductive flow meter according to the invention has at least one measuring electrode 17 for tapping a measurement voltage induced in the medium. For this purpose, the measuring electrode 17 is arranged in a measuring electrode opening in the measuring tube 2. The measuring electrode 17 has a measuring electrode head 30 and a measuring electrode shaft. The measuring electrode head 30 is configured to come into contact with the medium. The measuring electrode shaft extends through the measuring electrode opening. The measuring electrode head 30 has a measuring electrode diameter D_{ME} in the cross-sectional plane A. The measuring electrode head 30 does not necessarily have to be circular, but can also be elliptical in shape, with a longest extent in the longitudinal direction of the measuring tube.

The magnetic-inductive flow meter according to the invention has a reference electrode 20 for connecting the to-be-guided medium to an electrical reference potential. The reference electrode 20 is arranged in a reference electrode opening in the measuring tube 2. It has a reference electrode head 32, which is configured to come into contact with the medium, and a reference electrode shaft. The reference electrode shaft extends through the reference electrode opening. The reference electrode is arranged in the measuring tube 2 in such a way that a reference electrode longitudinal axis runs parallel to the main field axis of the generated magnetic field. In addition, a measuring electrode axis intersecting the measuring electrodes 17a, 17b intersects the reference electrode longitudinal axis perpendicularly. The reference electrode head 32 has, in a cross-sectional plane A of the measuring tube intersecting the reference electrode and the at least one measuring electrode, a reference electrode diameter D_{RE}. The measuring electrode head 30 has a measuring electrode diameter D_{ME} in the same cross-sectional plane A.

To reduce the measurement error, it is essential that the diameters be adjusted. The reference electrode diameter D_{RE} is in particular at least 10% and preferably at least 25% less than the measuring electrode diameter D_{ME}. Accordingly, a ratio D_{ME}/D_{RE} is greater than 1.3, in particular greater than 1.6 and preferably greater than 2. If one considers the dimensioning of the reference electrode head 32 relative to the measuring tube diameter D_{MR}, there is a ratio R=D_{RE}/D_{MR} for which 0.05≤R≤0.25, in particular 0.1≤R≤0.2 and preferably 0.13≤R≤0.17. Stated differently, a minimum distance d₁ between the measuring electrode 17a or 17b and the reference electrode 20 is required that is greater than 5 millimeters, in particular greater than 7 millimeters and preferably greater than 10 millimeters.

The illustrated magnetic-inductive flow meter 1 also has, in addition to the reference electrode 20, a fill-level monitoring electrode 22, which is arranged in a fill-level monitoring electrode opening of the measuring tube 2. However, magnetic-inductive flow meters without reference electrodes and magnetic-inductive flow meters without fill-level monitoring electrodes 22 are also part of the invention. The measuring electrodes 17a, 17b, the reference electrode 20, and the fill-level monitoring electrode 22 are arranged on the measuring tube 2 in such a way that they are intersected by the common cross-sectional plane A of the measuring tube 2. In one embodiment, the cross-sectional plane A is a plane of symmetry for the electrodes arranged on the measuring tube 2.

The fill-level monitoring electrode 22 has a fill-level monitoring electrode head 34 which is configured to come into contact with the medium when the latter is guided in the tube, and a fill-level monitoring electrode shaft which extends into the fill-level monitoring electrode opening. The fill-level monitoring electrode head 34 has, in the cross-sectional plane A of the measuring tube 2, a fill-level monitoring electrode diameter D_{FÜ}. In order to reduce the measurement error at low conductivities, it is essential that, when a fill-level monitoring electrode is present, the fill-level monitoring electrode diameter D_{FÜ} be in particular at least 10% and preferably at least 25% less than the measuring electrode diameter D_{ME}. Described differently, it is required that a minimum distance d₂ between the measuring electrode 17a, 17b and the fill-level monitoring electrode 22 be greater than 5 millimeters, in particular greater than 7 millimeters and preferably greater than 10 millimeters. If the advantageous diameters of the reference electrode and of the fill-level monitoring electrode are considered in relation to the measuring electrode diameter D_{ME}, the ratio D_{ME}/D_{FÜ} is greater than 1.3, in particular greater than 1.6 and preferably greater than 2. If the advantageous diameters of the reference electrode and of the fill-level monitoring electrode are considered in relation to the measuring tube diameter D_{MR}, for the ratio r=D_{FÜ}/D_{MR}, 0.05≤R≤0.25, in particular 0.1≤R≤0.2 and preferably 0.13≤R≤0.17. The advantage of the magnetic-inductive flow meter according to the invention is particularly evident in magnetic-inductive flow meters with measuring tube diameters D_{MR} less than 80 millimeters, in particular less than 50 millimeters.

FIG. 2 shows a cross-section through a second embodiment of the magnetic-inductive flow meter 101 according to the invention. The magnetic-inductive flow meter 101 differs from the embodiment of FIG. 1 essentially only in the number of measuring electrodes 107a-d, the positioning in the measuring tube, and contact with the measuring circuit 123. A longitudinal plane intersecting the reference electrode 120 and/or the fill-level monitoring electrode 22 divides the measuring tube 2 into a first measuring tube section I and an equally sized, second measuring tube section II. According to the invention, at least two measuring electrodes 107a, 107b, or, as shown in the illustrated embodiment, exactly two measuring electrodes 107a, 107b, are arranged in the first measuring tube section I. According to the invention, at least two measuring electrodes 107c, 107d, or, as shown in the embodiment illustrated, exactly two measuring electrodes 107c, 107d, are also arranged in the second measuring tube section II. The two measuring electrodes 107a, 107b and also the two measuring electrodes 117c, 117d are arranged on the measuring tube in such a way that their respective measuring electrode longitudinal axes span a midpoint angle α of 30≤α≤60°, in particular 40≤α≤50°. The measuring electrodes of a measuring tube section form a group and are electrically connected or short-circuited to each other. Thus, the measuring circuit 123 is not connected separately to the electrodes, but only to one measuring electrode of each group or to an electrically conductive connecting body which connects the at least two measuring electrodes of a group. In addition to the four measuring electrodes 117a-d shown, two further measuring electrodes can be provided, which—also as shown in FIG. 1—lie on a measuring electrode axis that intersects the main axis of the magnetic field lines perpendicularly.

FIG. 3 shows measurement results for a conventional magnetic-inductive flow meter and a magnetic-inductive flow meter according to the invention. The curve X was recorded using a conventional magnetic-inductive flow meter in which the two measuring electrodes, the fill-level monitoring electrode, and the reference electrode each have a circular cross-section and an identical diameter. At or above a conductivity value of 10³ μS/cm, the measurement error increases, as the conductivity decreases, until reaching a measurement error value of −3.5% at a conductivity of 10 μS/cm. The curve Y was recorded using a magnetic-inductive flow meter according to the invention, in which the diameters of the fill-level monitoring electrode and of the reference electrode were chosen to be significantly less than the diameters of the measuring electrodes. The diameter of the measuring electrodes in cross-section is 8 millimeters, and the diameter of the reference electrode and of the fill-level monitoring electrode is 4 millimeters. The series of measurements results in a maximum measurement error of approx. −0.8% for the curve Y. For conductivities above 10³ μS/cm, the determined measurement errors of the two magnetic-inductive flow meters differ only insignificantly.

### LIST OF REFERENCE SIGNS

Magnetic-inductive flow meter 1
Measuring tube 2
Carrier tube 3
Liner 4
Magnetic-field-generating device 5
Operating circuit 7
Controller circuit 10
Coil 13i
Coil core 14i
Measuring electrode 17i
Field return body 19
Reference electrode 20
Pole shoe 21i
Fill-level monitoring electrode 22
Measuring circuit 23
Evaluation circuit 24
Measuring electrode head 30
Reference electrode head 32
Fill-level monitoring electrode head 34
Magnetic-inductive flow meter 101
Measuring electrode 117i
Reference electrode 120
Fill-level monitoring electrode 122
Measuring circuit 123

1-11. (canceled)

12. A magnetic-inductive flow meter for detecting a flow-rate-dependent measurement variable of a flowable medium, comprising:
a measuring tube for guiding the medium;
a magnetic-field-generating device for generating a magnetic field that penetrates the measuring tube;
at least one measuring electrode for tapping a measurement voltage induced in the medium,
wherein the measuring electrode is arranged in a measuring electrode opening in the measuring tube,
wherein the measuring electrode has a measuring electrode head which is configured to come into contact with the medium;
a reference electrode for connecting the medium to a reference potential,
wherein the reference electrode is arranged in a reference electrode opening in the measuring tube,
wherein the reference electrode has a reference electrode head which is configured to come into contact with the medium,
wherein the reference electrode head has, in a cross-sectional plane A of the measuring tube intersecting the reference electrode and the at least one measuring electrode, a reference electrode diameter D_{RE},
wherein the measuring electrode head has, in the cross-sectional plane A, a measuring electrode diameter D_{ME},
such that
the reference electrode diameter D_{RE} is at least 10% the measuring electrode diameter D_{ME}.

13. The magnetic-inductive flow meter according to claim 12,
wherein a ratio D_{ME}/D_{RE} is greater than 1.3.

14. The magnetic-inductive flow meter according to claim 12,
wherein the measuring tube has a measuring tube diameter D_{MR},
wherein, for a ratio R=D_{RE}/D_{MR}, the following applies: 0.05≤R≤0.25.

15. The magnetic-inductive flow meter according to claim 12,
wherein a minimum distance d₁ between the measuring electrode and the reference electrode is greater than 5 millimeters.

16. A magnetic-inductive flow meter for detecting a flow-rate-dependent measurement variable of a flowable medium, comprising:
a measuring tube for guiding the medium;
a magnetic-field-generating device for generating a magnetic field that penetrates the measuring tube;
at least one measuring electrode for tapping a measurement voltage induced in the medium,
wherein the measuring electrode is arranged in a measuring electrode opening in the measuring tube,
wherein the measuring electrode has a measuring electrode head which is configured to come into contact with the medium;
a fill-level monitoring electrode,
wherein the fill-level monitoring electrode is arranged in a fill-level monitoring electrode opening of the measuring tube,
wherein the fill-level monitoring electrode has a fill-level monitoring electrode head,
wherein the fill-level monitoring electrode head is configured to come into contact with the medium,
wherein the fill-level monitoring electrode head has, in a cross-sectional plane A of the measuring tube intersecting the fill-level monitoring electrode and the at least one measuring electrode, a fill-level monitoring electrode diameter D_{FÜ},
wherein the measuring electrode head has, in the cross-sectional plane A, a measuring electrode diameter D_{ME},
such that the fill-level monitoring electrode diameter D_{FÜ} is at least 10% the measuring electrode diameter D_{ME}.

17. The magnetic-inductive flow meter according to claim 16,
wherein a minimum distance d₂ between the measuring electrode and the fill-level monitoring electrode is greater than 5 millimeters.

18. The magnetic-inductive flow meter according to claim 16,
wherein a ratio D_{ME}/D_{FÜ} is greater than 1.3.

19. The magnetic-inductive flow meter according to 16,
wherein the measuring tube has a measuring tube diameter D_{MR},
wherein the measuring tube diameter D_{MR} is greater than the fill-level monitoring electrode diameter D_{FÜ},
wherein, for a ratio r=D_{FÜ}/D_{MR}, the following applies: 0.05≤R≤0.25.

20. The magnetic-inductive flow meter according to claim 16,
wherein a longitudinal plane intersecting the reference electrode and/or the fill-level monitoring electrode divides the measuring tube into a first measuring tube section (I) and a second measuring tube section (II),
wherein at least two measuring electrodes, in particular exactly two measuring electrodes, are arranged in the first measuring tube section (I),
wherein the two measuring electrodes span a midpoint angle α of 30≤α≤60°.

21. The magnetic-inductive flow meter according to claim 16,
wherein the measuring tube diameter D_{MR} is less than 80 millimeters.

22. The magnetic-inductive flow meter according to claim 16,
wherein the measuring electrode and the reference electrode and/or the fill-level monitoring electrode are arranged on the measuring tube in such a way that they are intersected by the common cross-sectional plane A of the measuring tube.
